(19) United States
(12) Patent Application Publication
(10) Pub. No.: US 2022/0366334 A1
(43) Pub. Date: Nov. 17, 2022

(54) METHODS AND SYSTEMS FOR EFFECTIVE UTILIZATION OF AUTONOMOUS MACHINES

(71) Applicant: Caterpillar Inc., Peoria, IL (US)

(72) Inventors: Gautham Subramanian, Peoria, IL (US); Vijayakumar Ramasamy, Dunlap, IL (US); Gurumoorthy Ramalingam, Tamilnadu (IN); Arpeet Kumar, Navi Mumbai (IN)

(73) Assignee: Caterpillar Inc., Peoria, IL (US)

(21) Appl. No.: 17/322,569

(22) Filed: May 17, 2021

(51) Int. Cl. G06Q 10/06; G06N 20/00

(52) U.S. Cl. CPC G06Q 10/06311; G06N 20/00

(57) ABSTRACT

Systems and methods are disclosed for optimal utilization of machines for performing tasks across a predetermined area. A request may be initiated by interacting with an element of a graphical environment to perform a job on a predetermined area, the job including a plurality of tasks associated with a plurality of machines. In response to the request, a first machine of the plurality of machines may be deployed to the predetermined area to execute a first task of the plurality of tasks. A deployment event may be determined, and upon detection of the deployment event, a second machine may be deployed to the predetermined area to execute a second task of the plurality of tasks autonomously, the first task and the second task being indicated as elements of the graphical environment.

### TECHNICAL FIELD

The present disclosure relates generally to effective utilization of machines to perform tasks in an autonomous manner. More particularly, the present disclosure relates to utilization of machines to perform work at a worksite in a coordinated manner.

### BACKGROUND

In construction applications, including with the grading and compaction of dirt and other substrates on construction sites, autonomous and semi-autonomous machines may be used to perform certain tasks. The use of autonomous and semi-autonomous machines improves efficiency and reduces operational costs, but also introduces additional complexity, especially when activities of a plurality of machines occur on the same job site. In some cases, problems may arise in utilizing and coordinating these autonomous machines. For example, when a plurality of autonomous machines are performing related operations and/or operating in proximity to each other, these machines can interfere with each other or otherwise reduce the efficiency of work on the construction site.

A construction planning system is disclosed in U.S. Pat. No. 10,275,843 (the '843 patent) to Shike. The system described in the '843 patent acquires topography data and calculates construction plan data. This can facilitate the creation of a construction procedure and schedule in conjunction with a construction plan. An operator of the construction machine can perform work while viewing information presented on a display associated with the machine. While the system described in the '843 patent may be helpful for visualizing topology data or construction progress, it may be unable to coordinate the operation of a plurality of machines, including autonomous or semi-autonomous machines.

The systems and methods of the present disclosure may solve one or more of the problems set forth above and/or other problems in the art. The scope of the current disclosure, however, is defined by the attached claims, and not by the ability to solve any specific problem.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In one embodiment, a method of optimal utilization of machines for performing tasks across a predetermined area may include receiving a request initiated by interacting with an element of a graphical environment to perform a job on a predetermined area, the job comprising a plurality of tasks associated with a plurality of machines and deploying, in response to the request, a first machine of the plurality of machines to the predetermined area to execute a first task of the plurality of tasks. The method may also include determining a deployment event and upon detection of the deployment event, deploying a second machine to the predetermined area to execute a second task of the plurality of tasks autonomously, wherein the first task and the second task are indicated as elements of the graphical environment.

In another embodiment, a system of optimal utilization of machines for performing tasks across a predetermined area may include at least one processor and at least one non-transitory computer readable medium storing instructions which, when executed by the at least one processor, cause the at least one processor to perform operations. The operations may include receiving a request initiated by interacting with an element of a graphical environment to perform a job on a predetermined area, the job comprising a plurality of tasks associated with a plurality of machines, and deploying, in response to the request, a first machine of the plurality of machines to the predetermined area to execute a first task of the plurality of tasks. The operations may also include determining a deployment event and upon detection of the deployment event, deploying a second machine to the predetermined area to execute a second task of the plurality of tasks autonomously, wherein the first task and the second task are displayed as elements of the graphical environment.

In another embodiment, a method of optimal utilization of machines for performing tasks across a predetermined area may include receiving a request to initiate a job on a predetermined area, the job comprising a plurality of tasks associated with a plurality of machines and autonomously deploying, in response to the request, a first machine of the plurality of machines to the predetermined area to execute a first task of the plurality of tasks. The method may also include autonomously deploying a second machine to the predetermined area to execute a second task of the plurality of tasks autonomously and updating an element of a graphical environment based on a status of the first task and a status of the second task, the graphical environment including a plurality of segments that include a portion of the predetermined area, the first task and the second task being performed in respective segments of the plurality of segments.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 depicts an exemplary embodiment of a machine utilization optimization system, according to techniques presented herein.

FIG. 2 depicts an exemplary land area for machine utilization, according to techniques presented herein.

FIG. 3 depicts an exemplary display of a land area for machine utilization, according to techniques presented herein.

FIG. 4 depicts an exemplary display for managing machines, according to techniques presented herein.

FIG. 5 depicts an exemplary display for managing machines, according to techniques presented herein.

FIG. 6 depicts a flowchart illustrating an exemplary method of machine utilization optimization, according to techniques presented herein.

FIG. 7 depicts a flowchart illustrating an exemplary method of machine utilization optimization, according to techniques presented herein.

FIG. 8 illustrates an implementation of a computer system that may execute techniques presented herein.

### DETAILED DESCRIPTION

Both the foregoing general description and the following detailed description are exemplary and explanatory only and are not restrictive of the features, as claimed. As used herein, the terms “comprises,” “comprising,” “having,” “including,” or other variations thereof, are intended to cover a non-exclusive inclusion such that a process, method, article, or apparatus that comprises, has, or includes a list of elements does not include only those elements, but may include other elements not expressly listed or inherent to such a process, method, article, or apparatus.

In this disclosure, relative terms, such as, for example, “about,” substantially,” “generally,” and “approximately” are used to indicate a possible variation of ±10% in the stated value. The term “exemplary” is used in the sense of “example” rather than “ideal.” As used herein, the singular forms “a,” “an,” and “the” include plural reference unless the context dictates otherwise.

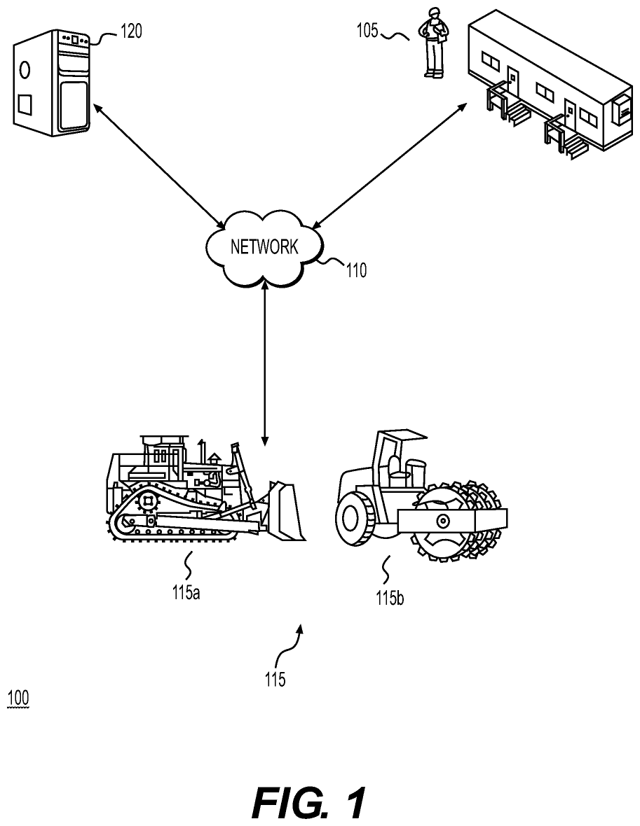

FIG. 1 depicts an exemplary embodiment of a machine utilization optimization system 100, according to techniques presented herein. At least one operator 105 may interact with a network 110 to communicate with and/or control the operation of one or more machines 115. The operator 105 may be located within line-of-sight (LOS) of the machines 115, and may communicate with and/or control the machines 115 via a remote control device. Alternatively, the operator 105 may be located in a back office on-site or off-site from where the machines 115 are being utilized. The operator 105 may also be located inside one of the machines 115, where he or she may be able to directly control machines 115. Some or all or the operations of the machines 115 may occur without operator engagement, and hence the machines 115 may operate autonomously or semi-autonomously. For example, the machines 115 may have onboard software controlling some or all of their operations, and/or the machines 115 may be partially or completely controlled by instructions received from server(s) 120 across the network 110.

Instructions received from server(s) 120 may be generated by one or more control systems located in an on-site or off-site back office. These instructions may be automatically generated by these control system(s) in response to mission(s) (a group of actions for one or more machines that perform a particular task, such as grading, compacting, etc.) created by the operator 105. In some aspects, instructions received from server(s) 120 may be generated based on remote operation inputs received by operator 105 when remotely controlling a machine 115 (e.g., based on handheld controller inputs, joystick inputs, pedal inputs, keyboard inputs, mouse inputs, touchscreen inputs, etc.), or a combination of automatically generated instructions and instructions based on remote operation inputs. Remote operation may be performed at a remote control station where one or more systems are present for operating differing types of machines. The remote control station may correspond to the back office, or may be separate from the back office. While depicted as separate from the operator 105, the server 120 may be directly accessible to the operator 105. The server 120 may execute machine utilization software to control the machines autonomously, as will be discussed further herein.

For a given plot or area of land utilizing multiple machines 115, which may be referred to as a “work site” herein, a number of challenges arise with efficient and safe utilization. For safety reasons, machines 115 might not be allowed to come within a predetermined distance of each other. However, all other things being equal, the work site preparation will be accomplished faster if there are multiple machines operating on the work site at once. Often, a machine must wait for another machine to treat a given portion of a work site before it may begin its own mission. Thus, machines may be waiting for each other, which is costly and inefficient. Yet, if the second machine begins its mission too early, it may catch up to the first machine, requiring the first machine to stop repeatedly during the first machine's mission, which is also inefficient, and may lead to safety issues. Techniques are discussed herein to resolve these and other challenges.

The machines 115 may have on-board safety protocols that cause them to deny certain task requests received from operator 105 and/or server 120. For example, a machine may stop if it detects a person, object, or other machine within a predetermined proximity. The machine may also decline any task/mission instruction received if, for example, the detected grade of an area is too steep, or other site characteristics are not considered safe. In addition, each machine 115 may have minimum working area requirements. Accordingly, if the server 120 instructs a machine to perform a mission/task to treat an area smaller than the minimum, the machine may decline the mission.

The machines 115 may be continuously reporting their location, speed, surroundings, and/or other situational data back to the server 120 and/or operator 105. The server 120 and/or operator 105 may use this data to determine subsequent instructions to the machines 115. For example, the server 120 may instruct a machine 115a to stop if it comes within a predetermined area being utilized by machine 115b, even if on-board proximity sensors of machine 115b have not yet been tripped. This feature may be especially advantageous for a fleet of autonomous machines operating at a remote location.

While FIG. 1 depicts two exemplary machines 115 (machines 115a and 115b), a single work site in which machines of machine utilization optimization system 100 operate may include three, four, five, or more machines. Any subset of these machines may operate in conjunction with each other in one area of the work site (e.g., a particular portion of the work site) while another subset of the machines work in another area of the work site. Additionally, machines 115 may include three, four, five, or more different types of machines. Exemplary types of machines include motor graders, dozers, compactors, trucks, excavators, loaders, cold planers, pavers, track loaders, skid steers, mining machines, and others.

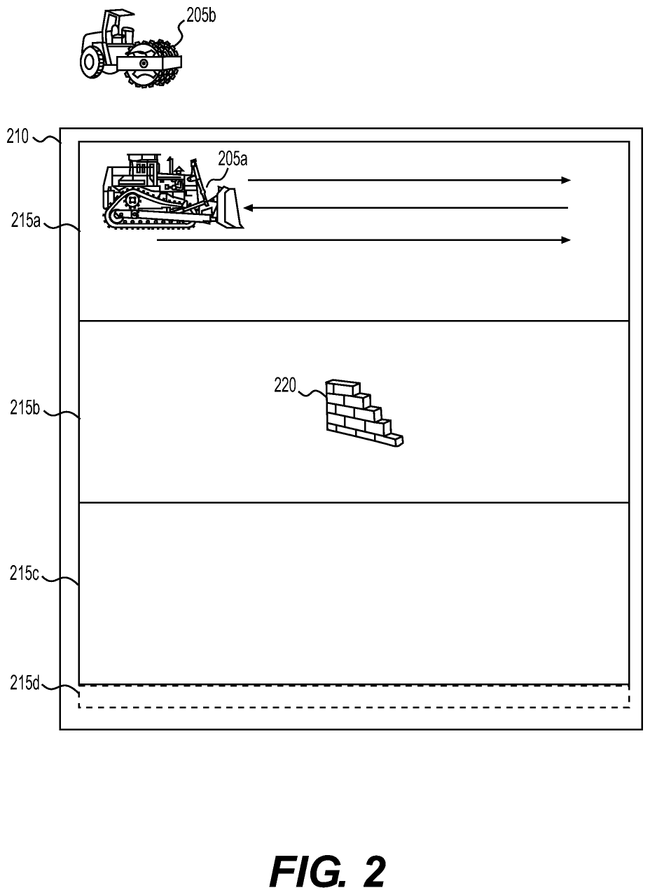

FIG. 2 depicts a work environment 200 including an exemplary work site for machine utilization, according to techniques presented herein. In the figure, work site 210 is being operated on first by machine 205a, and will subsequently be worked on by a different type of machine 205b. In this example, machine 205a includes a motor grader and/or a dozer (collectively referred to below as a dozer for clarity), and machine 205b is a compactor (e.g., a vibratory soil compactor). Once the grading of the work site 210 is completed by the dozer 205a, the work site may be compacted by the compactor 205b. In an autonomous environment, via the utilization application algorithm, the server 120 may seamlessly and autonomously coordinate the operation of the two machines to complete their respective missions on the work site 210.

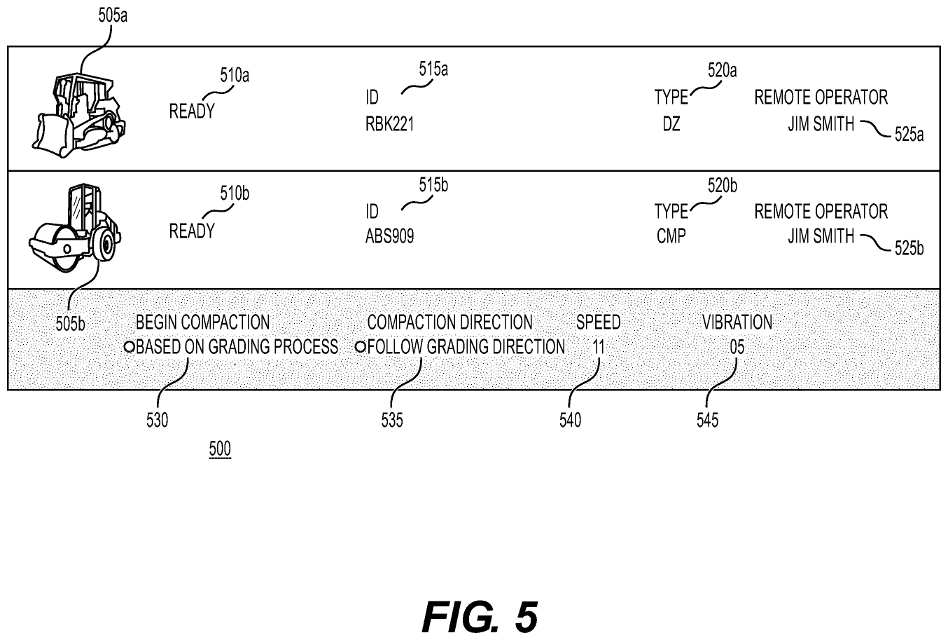

A first goal may be to have both machines operating at once, in order to minimize the time that each machine is in an idle state. A second goal may be to avoid unwanted task creation from the back office for creating subsequent tasks. For example, the operator 105 in the back office may prefer to simply send one request to the server 120 to have the work site 210 graded and compacted, as described below with respect to FIG. 5, for example. However, if the compactor 205b is sent out too early, it may catch up to the dozer 205a (e.g., when compactor 205b operates at a faster rate as compared to dozer 205a), or otherwise come within a predetermined distance of the dozer 205a (e.g., when paths of compactor 205b and dozer 205a extend proximate to each other), which may cause one or both of the machines to stop and/or disengage autonomous mode at various locations on the work site 210. At this point the operator 105 may have to send another task request to reinitiate the mission. If the compactor 205b catches the dozer 205a again, intervention by the back office may again be required, and so on. Accordingly, the server 120 may instruct the compactor 205b to stay in an idle state for a specific amount of time. Once the specific amount of time is elapsed the compactor 205b may resume the mission. The passage of specific amount of time allows the compactor 205b to operate without catching up or interfering with the operation of the dozer 205a on the work site 210. The specific amount of time may be determined based upon the specified, measured, or desired average speed of each machine, the site characteristics, etc., as will be discussed further below.

Further challenges may arise with having two autonomous machines operating simultaneously on the work site 210. The boundary of the work site may be large, and, if left on their own to operate autonomously, machine 205b may perform work on an area that has not yet been treated by machine 205a. To avoid the aforementioned challenges, the work area may be divided into a plurality of work areas or segments, such as segments 215a-215d.

Machines 205a and 205b may be prohibited from entering any segment 215a-215d occupied by another machine (e.g., the other one of machines 205, 205b, or another autonomous, semi-autonomous, or manually operated machine). If any autonomously-operating machine leaves a segment to which it is assigned, it may automatically be brought out of autonomous mode and/or stopped, for example by server 120. This may both improve safety and reduce the likelihood that a machine will treat an area out of turn. For example, the dozer 205a may first grade segment 215a, then move on to segment 215b. At this time, the server 120 may instruct the compactor 205b to begin work on segment 215a. Alternatively, the server 120 may determine that compactor 205b will likely finish segment 215a before the dozer 205a finishes segment 215b. In such an instance, the server 120 may have the compactor 205b wait longer in order to avoid a stoppage.

When determining the work site segment sizes, on the one hand a smaller segment may improve the utilization percentage of the machines, since it may allow a second machine to start on the work site sooner. However, larger segments may improve safety, in keeping machines further apart, and may help ensure that machines can get around any obstacles without leaving their segment, such as obstacle 220. The site manager may configure a desired segment size based on the nature of the mission, nature of the task and the like. In one embodiment, the server 120 may attempt to define work site segments as small as possible while factoring in a variety of considerations, including 1) machine dynamics, 2) site attributes, 3) possible utilization ratios of the machines, and/or 4) safety.

Machine dynamics may include machine height, measured/specified/desired speed of the machine, and/or overall size of the machine. Additionally, the machine type, turn over radius, and maneuver area required to turn the machine may also be considered. For larger machines moving at a faster speed, the segment size may be increased. This is because larger and/or faster machines may need more room to slow down before stopping upon reaching the end of the segment. For example, the server 120 may determine that a machine that moves at 6 km/hour requires 15 feet of stopping distance. The size and speed of the machine, required stopping distance, turning radius, etc., may separately or together put a lower bound on minimum size of the segment.

The machine itself may have internal checks that may cause it to decline the proposed segment boundary. For example, if the server 120 provides a segment that is 15 feet long, the machine may decline, as the machine itself may have sensors that require 15 feet in front of the machine unobstructed to begin moving. Accordingly, each machine may have corresponding minimum segment size requirements. The server 120 may be aware of these machine-specific minimum predetermined dimensions, and may ensure that any proposed segment size is larger than these dimensions.

As discussed above, the server 120 may also consider site attributes when determining segment sizes. Possible paths may be considered. For example, if the grade of the work site 210 only permits or requires one or more of the machines to move back and forth in an east/west (or some other) direction, then segments may be defined such that the long side of the segment is in the east/west direction. Server 120 may also consider how far away the idling/parking area for the machines is from the work site 210 (for example, there may be some restrictions that subsequent machines need the boundary to be a minimum of a predetermined number of feet). Additionally, the type of substrate, topology, or starting level of compaction on the work site 210 may be considered, as this may affect the speed at which the machines can move, and thus the required stopping distances, etc.

Obstacles 220 on the work site 210 may also be considered. For example, the algorithm executed by the server 120 may expand the size of an individual segment to ensure that any machines can get around any obstacles without straying into another segment. For example, in response to determining obstacle 220, the server 120 may enlarge segment 215b beyond other segments lacking obstructions. Accordingly, the segments are not necessarily identically sized. Obstacles 220 may be identified by the server 120 from map data (e.g., GNSS data) or based on information supplied by operator 105 (e.g., based on the operator's knowledge of the work site 210). In at least some configurations, obstacles 220 may be detected by machines 205 by sensors located on the machine 205 and/or at the work site 210. Suitable sensors for detecting an obstacle 220 may include optical systems (e.g., cameras), radar, and/or other suitable sensors.

As discussed above, the utilization ratio may also affect segment size. The server 120 may seek to maximize the utilization of the machines 205. Once a machine is brought up from the parking/idling area, it may be a goal that it is used continuously until no longer needed. This is both to complete the tasks on the work site 210 as quickly as possible, as well as to prevent stoppages that may require back office/operator 105 intervention. The goal may be to have consecutive machines with equal utilization ratios. The utilization ratios may correspond to the percentage of time a given machine is used between when it is initially summoned and when its mission is complete. If the segment size is too large, for example, subsequent machines such as the compactor 205b may sit idle for much longer than required to achieve continuous usage. As a result, utilization ratio considerations may encourage as small a segment size as possible, without infringing any requirements from one of the other considerations.

Considerations of effective utilization may also include the degree to which the machines involved with the job move in the same direction. The quality of the final work site surface may be of higher quality if the machines move in at least approximately the same orientation. Segments may accordingly be shaped as longer rectangles so that autonomous machines will all have to perform their missions in substantially the same direction.

Finally, safety considerations may affect the selection of the segment size. The machines may require a minimum radius in front or around them to remain clear, for example. Pit holes and other obstacles may be considered. Pending weather may be considered. Possible or likely human intervention scenarios may be considered. The needed size of the maneuverability area may be considered. Thus, safety considerations may set a lower limit on the segment size.

The server 120 might automatically extend the segment boundary, if possible, to ensure that the entire segment area is treated with the task. For example, the corners of the segment might not otherwise receive grading, compaction, or whatever the intended task requires, since the machine will not be able to go up to the very edge of the segment. Thus, a boundary extension may be determined machine-by-machine, as different machines have different turning radiuses, etc.

As the algorithm on the server 120 iterates across the work site 210 determining segments, there may be a slightly too small end segment, as shown in segment 215d. In such a case, in order to avoid having a segment size that violates the safety and machine considerations, etc., discussed above, the smaller segment may be absorbed into the nearest full-sized segment. For example, segment 215d may be incorporated into segment 215c.

Accordingly, an algorithm on the server 120 may automatically segment the work site based upon the above considerations. This may be performed upon receiving a task request from the operator 105. As a result, the operator 105 might never need to determine and/or manually enter segments, schedule machine movements or start times, etc.

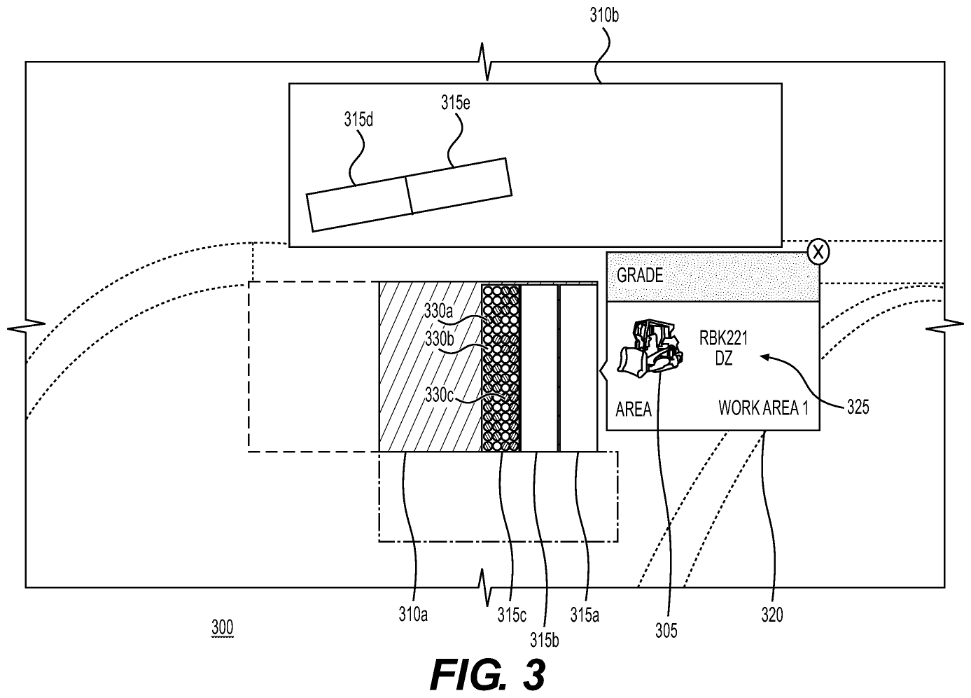

FIG. 3 depicts an exemplary graphical environment 300, for example a graphical user interface, useful as a display of a land area for utilizing a plurality of machines, including one or more autonomous or semi-autonomous machines. Each of the individual elements of graphical environment 300 may be presented (e.g., displayed) by one or more devices associated with the server 120 and/or with operators 105, including back office operators 105. These elements may be presented in response to commands from server 120, for example.

Environment 300 may include representations of one or more work sites, two work sites 310a and 310b being shown in FIG. 3. Environment 300 may be generated based on satellite imagery showing a prior state of a work site. If desired, environment 300 may be generated with current (e.g., real-time and/or updated) information, such as machine scanning, drone scanning, and/or other processes. Whether environment 300 is generated based on previous information, current information, or both, environment 300 may illustrate a portion or entirety of a work site, overlaid with information representative of the status of one or more missions and/or one or more machines operating autonomously, semi-autonomously, or manually. Work sites 310a, 310b may correspond to one or more work sites 210, and may be divided into a plurality of segments, such as segments 315a-315e. Environment 300 may further contain a status notification 320.

Each segment 315a-315e may represent a segment defined by the server 120. These segments may be automatically generated and/or adjusted by the server 120, based on the above-described machine dynamics and other considerations. In some configurations, one or more segments may be defined, at least partially, based on an interaction, by operator 105, with a graphical element of environment 300 and/or by otherwise interacting with server 120. For example, the operator 105 may input a desired segment size (e.g., by resizing a segment or by inputting a value representative of an area, a length, a width, etc., of a segment). The operator 105 may also input one or more of the machine dynamics, such as a machine height, measured/specified/desired speed of the machine, and/or overall size of the machine. This may be performed by inputting one or more values indicative of these machine dynamics, or by providing an identity of a particular machine to the server 120. A user may also be able to manually reposition and/or rearrange segments 315a-315e by interacting with a device associated with environment 300, such as one or more back end systems and/or server 120. Operator 105 may also indicate a location of an obstacle, to allow the server 120 to resize and/or reposition one or more segments 315a-315e as necessary. However, as described above, each segment 315a-315e may be generated by server system 120 such that the operator 105 might never need to determine and/or manually enter segments.

One or more segments may also be presented via environment 300 in a manner that illustrates progress of a mission with respect to these one or more segments. For example, for a mission that includes grading segment 315c of work site 310a, graphical surface portions 330a-330c may represent the condition or work progress of corresponding portions of the actual work site. These portions may correspond to areas where additional work is needed (e.g., where cutting or filling is required) and where work is not needed and/or has been completed. In the example of grading, surface portions 330a may represent areas where cutting is needed, surface portions 330b may represent areas where no work is needed (e.g., the surface has desired characteristics), and surface portions 330c may represent areas where filling is needed. Portions 330a-330c may be represented in any suitable form. For example, portions 330a-330c may be presented as a plurality of geometric shapes with different colors or patterns (e.g., triangles, circles, rectangles, etc.), as a gradient of colors, etc.

Status notification 320 may indicate a status of a particular segment. In the example shown in FIG. 3, notification 320 is indicative of segment 315a. Notification 320 may identify segment 315a (e.g., as “Work area 1”) and may identify a machine 305 currently working in segment 315a or scheduled to work in segment 315a. Notification 320 may also present one or more identifiers 325 of machine 305. Identifiers 325 may identify a type of machine (e.g., “DZ” representing a dozer) and, in particular, a model of the machine (e.g., “RBK221” representing a particular model number and/or serial number). When machine 305 is currently operating in a semi-autonomous or manual mode, identifiers 325 may identify an operator identified with machine 305, similar to the operator identifiers discussed below.

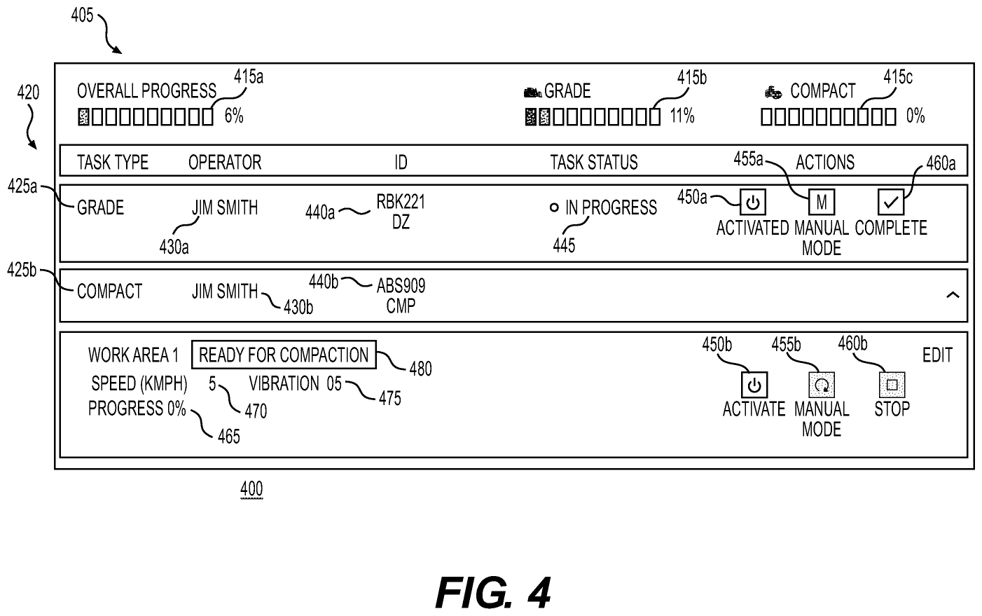

FIG. 4 shows an exemplary graphical environment 400, such as a graphical user interface, that may correspond to a back end system or remote control station. Graphical environment 400 may be presented by a system configured to enable remote operation of one or more machines for manual or semi-autonomous remote operation. Graphical environment 400 may further be suitable for monitoring progress of a group of tasks or missions, as well as progress of one or more individual missions. In particular, environment 400 may present progress notifications 405, machine-based notifications 420, and/or segment-based notifications (e.g., notifications 465, 470, 475, and 480). In the example shown in FIG. 4, a first machine (a dozer) may be currently operating in an autonomous mode, while a second machine (a compactor) is not yet deployed.

As shown in the upper portion of FIG. 4, environment 400 may include notifications 405 that are indicative of progress of a project or group of tasks or missions. This overall progress may be illustrated as notification 415a. Individual missions (e.g., grading and compacting) may be represented by individual notifications 415b and 415c. Notifications 415b and 415c may be indicative of a group of segments, or a single particular segment. Notifications 415a-415c may have any suitable form, including text, graphics (e.g., progress bars, colors, wheels, etc.), numbers (e.g., completed percentage, remaining percentage, estimated additional work time required for completion, elapsed work time, etc.), or any combination of these.

Machine-based notifications 420 may include task type notifications 425a, 425b, operator identifying notifications 430a, 430b, machine identifying notifications 440a, 440b, and status notifications 445. Task type notifications 425a, 425b may indicate a particular mission that is being performed, or will be performed, by a particular machine identified by notifications 440a, 440b. Operator identifying notifications 430a, 430b may identify a remote operator 105 associated with the machine, an on-site operator (e.g., an operator 105 within a cabin of the machine), or an operator 105 supervising the progress of the machine (e.g., when the machine operates autonomously). Status notifications 445 may indicate a status of the mission, and may be updated continuously or intermittently, for example in real-time or near real-time, as the task is being performed.

In configurations where environment 400 is associated with a remote operation system, environment 400 may include one or more command elements 450a, 455a, or 460a. In some aspects, these elements 450a, 455a, and 460a may be associated with a particular segment, machine and/or mission, while another group of elements 450b, 455b, 460b may be associated with another segment, machine, and/or mission. Command elements may be indicative of a mode of a machine associated with a particular mission, and may allow a remote operator to issue commands for autonomous or semi-autonomous operation of the machine. For example, an activation element 450a may indicate whether a machine is currently activated (e.g., currently being autonomously, semi-autonomously, or manually operated). When a machine is not currently being operated and is available, an activation element (e.g., element 450b) may enable activation for autonomous activation (e.g., deployment) of the machine.

Manual mode activation elements 455a and 455b may be configured to indicate whether manual mode (e.g., manual remote operation of a machine) is currently available. For example, when a machine is activated and available for manual operation, the activation element may indicate this condition by text, color, and/or shape, for example, as represented by activation element 455a. When a machine is not yet activated, or is otherwise unavailable for manual operation, activation element 455b may indicate this condition (e.g., by shading, text, and/or other forms).

A status indicator may indicate a current deployment status of a machine. For example, when deployment is complete, element 460a may be presented. Element 460a may provide a notification that deployment is complete. When a deployment has not yet begun (e.g., a machine has not yet been activated) an element 460b may be presented with text and/or shading indicative of this condition. When a machine is in the process of activation, element 460b may provide a notification that deployment is continuing, but can be stopped. Element 460b may also notify that deployment has not yet begun.

Segment-based notifications 465, 470, 475, and 480 may be elements that identify a status of work progress for a particular segment, work parameters associated with a particular segment, among others. A segment status notification 465 may indicate an amount of progress for a specific segment. Work parameter notifications 470 and 475 may indicate work conditions associated with a particular machine as it performs a tasks/mission on this segment. In the example of compaction, work parameter notifications may include a speed notification 470 (e.g., a desired speed, maximum speed, and/or minimum speed). An implement work parameter notification 475 may specify one or more conditions for the operation of an implement (e.g., an amount of vibration of a drum of a compactor, such as high, medium, and/or static compaction settings).

Environment 400 may further facilitate the display of notifications, such as messages, to and from the back office. For example, a segment-based notification may indicate that a particular segment is ready for a mission. In the example illustrated in FIG. 4, an identified work area (e.g., work area 1, which may correspond to segment 315a) may be ready for compaction, as indicated by notification 480. Various other messages or notifications may be presented to back office systems, remote operation systems, and machine systems (e.g., systems inside a cabin of a machine).

Messages or notifications may also be generated and transmitted to user devices associated with operators, such as on-site machine operators (operators that operate a machine from within a cabin of the machine), remote machine operators, back office operators, etc. For example, an operator manually operating a machine may be notified, via a display in the cabin on the machine or a personal system such as a portable computing device, that a segment is available for a particular type of task or mission. As shown in FIG. 4, a back office or remote operator may similarly be notified that a particular segment is ready for a particular type of task or mission.

FIG. 5 shows an exemplary graphical environment 500, such as a graphical user interface, associated with creating one or more missions. Graphical environment 500 may, similar to environment 400, be presented on one or more back office systems and/or other systems in communication with the server 120. As shown in FIG. 5, environment 500 may include a plurality of graphical elements that facilitate generation of coordinated missions between a plurality of machines. Each machine may be identified with a graphical notification 505a, 505b, a status notification 510a, 510b, an identifier 515a, 515b, a machine type notification 520a, 520b, and/or an operator notification 525a, 525b.

Environment 500 may also include one or more mission parameter elements. Mission parameter elements may include a precondition element 530 that may indicate a condition that, when satisfied, will cause server 120 to control a machine to perform a mission. In the example illustrated in FIG. 5, a mission for a compactor may begin (e.g., a compactor may be deployed to a segment) when grading in that segment is complete. Precondition element 530 may also indicate a condition under which a message is transmitted to back office systems and/or to an operator. For example, when a segment is ready for compaction, based on grading, a message may be transmitted to the back office and/or operator 105 to begin compaction. Additional or different preconditions may be set by interacting with precondition element 530. A work performance element 535 may indicate how work will be performed (e.g., based on the direction of grading). Server 120 may be configured to generate commands for autonomous control of a machine based on the elements 530, 535 input (e.g., selected) via environment 500.

Work parameter elements may include a speed element 540 (e.g., a desired speed, maximum speed, and/or minimum speed) and an implement element 545. Implement element 545 may specify the operation of an implement (e.g., an amount of vibration of a drum of a compactor, such as high, medium, and/or static compaction settings).

Each of the elements of environment 500 may be modified by server 120 and/or by an operator interacting with a back office system, in order to set parameters for performing a mission. In particular, environment 500 may allow an operator to select: particular types of machines or individual machines, a remote operator, preconditions, work performance, and/or speed and implement operations by interacting with elements of environment 500.

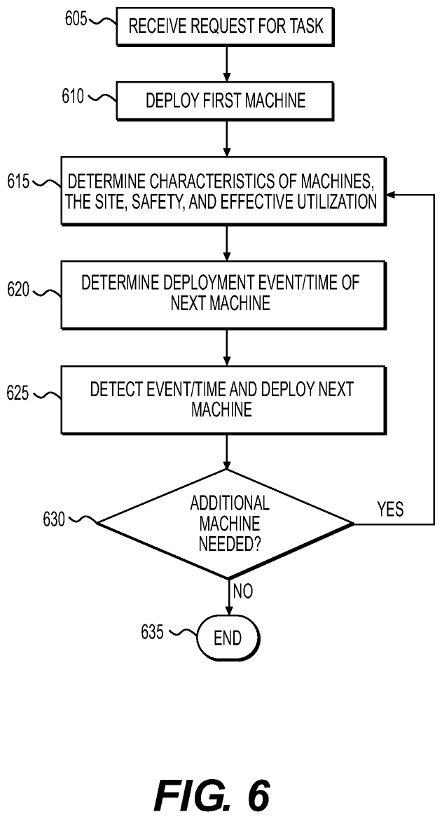

FIG. 6 is a flowchart illustrating an exemplary method of machine utilization optimization, according to techniques presented herein. At step 605, a request may be received to perform a task. This may be a request from the operator 105 received at the server 120 to complete a task requiring multiple machines to perform tasks/missions on a work site 210. This request may be generated by an operator's 105 interaction with environment 400 and/or environment 500.

At step 610, in one embodiment a first machine may be deployed to perform a mission on the work site 210. Alternatively, the first machine might only be deployed after segments, etc., are determined, such as at step 625. For example, before deploying any machines, server 120 may develop a work site plan designating machines used, events that will trigger their deployment, time estimates, speeds, and/or segments, etc. Alternatively or additionally, a first machine may be deployed, and feedback information from the first machine may be used to create or update the work site plan. As discussed above, this first machine may provide information back to the server 120 and/or operator 105, such as percent completed (which may be presented in environment 400 as indicators 415a-415c), estimated time remaining, and machine-specific progress indicators such as compaction metrics (over or under compacted surface in a map, as represented by surface portions 330a-330c). The first machine may be deployed in a fully autonomous manner, based on the received request. If desired, the first machine may be deployed in a semi-autonomous manner by an operator interacting with environment 400.

At step 615, characteristics of the machines needed to perform the requested task, the work site 210, safety factors, and/or effective utilization information may be received. At this time, as discussed above, segments may be determined to divide up the work site 210. Alternatively, for example if segments are not determined, this information may simply be used to determine a start time of the next machine. In some embodiments, step 615 may include determining segments based on a boundary set by an operator (e.g., a boundary of work site 210). Step 615 may also be performed, at least in part, based on information received by interactions with environment 300 (e.g., work sites 310a, 310b, and/or segments 315a-315e).

At step 620, an event or time for the deployment of the next machine may be determined. The location of the next machine relative to the work site 210 may be considered, and the machine may be summoned at a time that it may immediately begin work on the work site 210 upon arrival from the parking/idling area. The start time/event of the next machine may be modified based on the progress information being received from the first machine. For example, the server 120 may initially estimate or otherwise calculate that compactor 205b may start compacting immediately when the dozer 205a enters segment 215b, which may be based on an estimated average speed of the dozer 205a. However, if the dozer 205a is making slower progress than expected (e.g., operating at a measured average speed that is slower than the estimated average speed), the server 120 might not instruct the compactor 205b to enter segment 215a until the dozer 205a reaches segment 215c. Alternatively, the server 120 might not instruct the compactor 205b to enter segment 215a until dozer 205a reaches a calculated location within segment 215b, or has completed a calculated portion/percentage of segment 215b.

Alternatively, the requested task from the operator 105 may require multiple machines of the same type. For example, if the work site 210 is entirely ready for compaction, and there are multiple compactors 205b available, one of each compactor may be assigned a mission by the server 120 to compact soil on one segment, or a collection of segments, simultaneously. Each compactor may be assigned to begin at the same end of the segment to which it is assigned. For example, the compactors may all begin at the northwest corner of their respective initial segment and work compacting towards the southwest corner of their segment. In this way the compactors are less likely to encounter each other at segment edges.

If at any time a machine or the server 120 determines that the machine cannot complete the segment, perhaps due to being stuck or disabled, the server 120 may determine if another machine is available that may complete the segment, or that may begin work on the following segment that would have been completed by the now unavailable machine. For example, if a machine is stuck in the mud in segment 215a, the entire segment may be temporarily taken down, and a replacement machine may be deployed to begin work on the subsequent segment 215b. Any subsequent machines may automatically begin their work also at segment 215b.

Machine learning techniques may additionally be employed to help determine the deployment event/time that will cause the next machine to be summoned. For example, in one embodiment the purported speed of the machine and apparent site characteristics may be used to determine when the second machine is released, brought out of parking, etc. Alternatively, the server 120 may utilize a machine-learning system that compares features of the current site, machines, etc., to similar construction sites and historical data associated therewith. For example, at least one feature vector, associated with the current work site 210, may be created using machine dynamics data and/or site attributes data and/or utilization ratio data and/or safety data. This feature vector may be compared to prior feature vectors associated with other construction sites that have already been completed in order to predict when the second or subsequent machines will be needed. This process may be performed iteratively, as data is received from machines operating on the work site.

Similar machine learning techniques may be used to determine segment size. For example, the historical data may indicate that, for this type of soil, the stoppage distance or maneuver area is larger than the specifications indicate. By comparing feature vectors of the current work site 210 with feature vectors of prior completed work sites, the optimum segment size may be more accurately determined.

At step 625 the event or time for deployment of the next machine may be detected, and the next machine may then be deployed. For example, if it is determined that the dozer 205a has exited segment 215a, the compactor 205b may be instructed to begin compaction on segment 215a. The second machine may also provide information back to the operator 105 and server 120. For example, after the compactor 205b begins its mission compacting the compaction targets, it may report location, pass, machine driver power (MDP) level-of-compaction information, compaction meter value (CMV) level-of-compaction information, etc. This information may be used to help determine a start event or time for any subsequent machines, and may be used to determine when to automatically move machines from the parking area to the work site 210. Machines may be moved from the parking/idling area with a universal remote control station, non-line of sight (NLOS), etc.

Step 625 may include, in some embodiments, generating a notification when the event or time for deployment of the next machine is detected. For example, a notification may be generated by the server 120 to the back office. This notification may correspond to notification 480, for example. Additionally or alternatively, a message may be generated and transmitted to a device associated with operator 105 at the back office and/or remote control station, and/or an operator 105 manually operating a machine. The deployment may be performed in step 625 based on an interaction with a graphical element, such as elements 450b or 455b.

In following these steps, multiple machines may safely and efficiently work on the work site 210 simultaneously. These steps may be performed iteratively. At step 630, if it is determined that an additional machine is needed, the algorithm, which may be located on server 120, may loop back to step 615 and begin again. Additionally, the above-described notifications and elements of environments 300 and 400 may be updated continuously or periodically based on the determined event or time for deployment of the next machine.

If no more machines are required to treat the work site 210, the process may end at step 635.

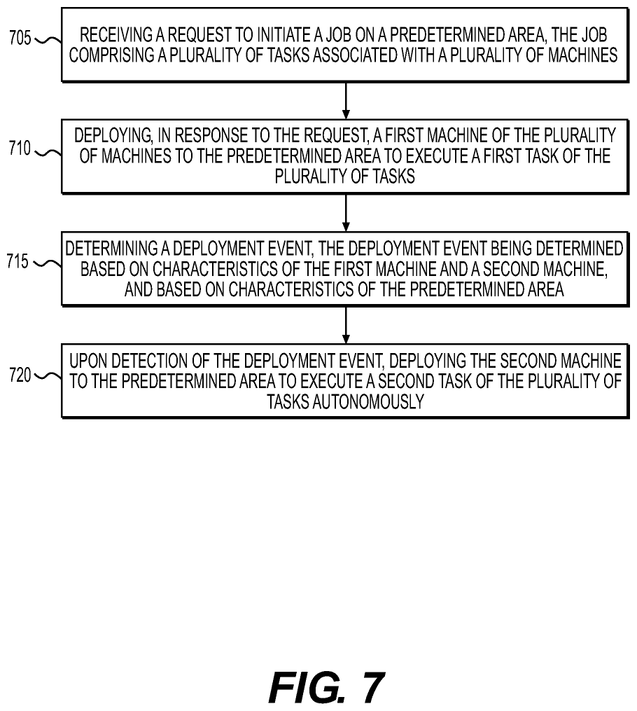

FIG. 7 is a flowchart illustrating an exemplary method of machine utilization optimization, according to techniques presented herein. At step 705, a request may be received, for example at server 120, to initiate a job on a predetermined area, the job comprising a plurality of tasks associated with a plurality of machines, for example machines 115/205.

At step 710, in response to the request, the server 120 may deploy a first machine of the plurality of machines to the predetermined area to execute a first task of the plurality of tasks autonomously. Step 710 may include, additionally or alternatively, performing the first task manually or semi-autonomously.

At step 715, a deployment event may be determined based on the characteristics of the first machine and a second machine. The deployment event may further be determined based on characteristics of the predetermined area. The deployment event may comprise, as discussed above, the first machine entering a predetermined segment, or the first machine reaching a predetermined location such that the second machine will be able to perform its task without interruption, or the first machine a predetermined portion of its task or segment, for example. The deployment event may also be modified based on data received from the first machine. For example, if the first machine is moving slower or faster than expected, or has mechanical or movement/terrain problems. Additionally, the deployment event may be based on semi-autonomous or manual operation of a machine, as well as based on a user's interaction with one or more graphical elements, as described above.

At step 720, the deployment event may be detected, which may result in the server 120 deploying the second machine to the predetermined area to execute a second task of the plurality of tasks autonomously.

While the above description of FIGS. 6 and 7 refers primarily to work site 210, the above-described steps are equally applicable to work sites 310a and/or 310b, and the above-described features associated with environment 300.

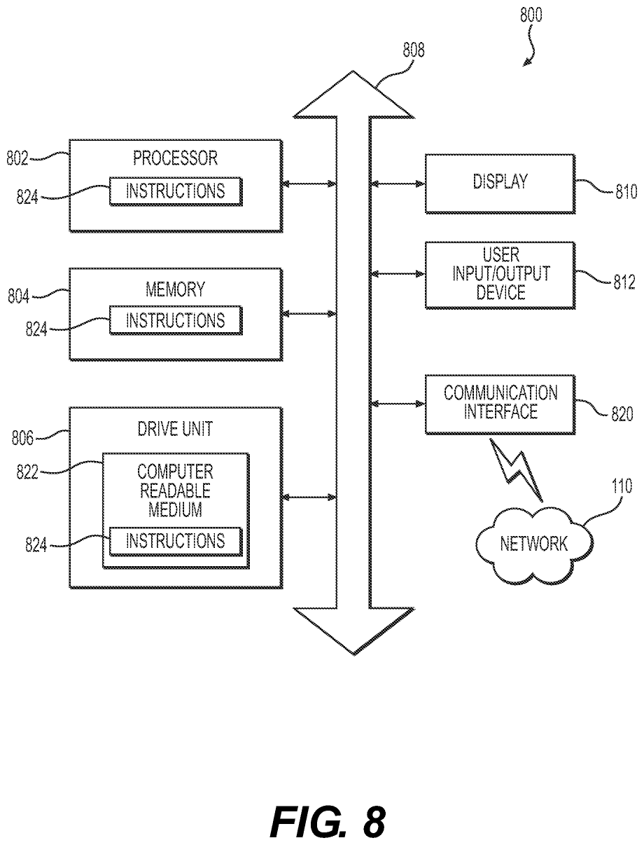

FIG. 8 illustrates an implementation of a computer system 800, which may correspond to server 120 and/or any device(s) used by operator 105. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system 800 may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 800 can be implemented using electronic devices that provide voice, video, or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 804 includes a cache or random-access memory for the processor 802. In alternative implementations, the memory 804 is separate from the processor 802, such as a cache memory of a processor, the system memory, or other memory. The memory 804 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts or tasks illustrated in the figures or described herein may be performed by the programmed processor 802 executing the instructions stored in the memory 804. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 800 may further include a display 810, such as a liquid crystal display (LCD), an organic light emitting diode (OLED), a flat panel display, a solid-state display, a cathode ray tube (CRT), a projector, a printer or other now known or later developed display device for outputting determined information. The display 810 may act as an interface for the user, such as operator 105, to see the functioning of the processor 802, or specifically as an interface with the software stored in the memory 804 or in the drive unit 806.

Additionally or alternatively, the computer system 800 may include an input device 812 configured to allow a user to interact with any of the components of system 800. The input device 812 may be a number pad, a keyboard, or a cursor control device, such as a mouse, or a joystick, touch screen display, remote control, or any other device operative to interact with the computer system 800.

The computer system 800 may also or alternatively include a disk or optical drive unit 806. The disk drive unit 806 may include a computer-readable medium 822 in which one or more sets of instructions 824, e.g. software, can be embedded. Further, the instructions 824 may embody one or more of the methods or logic as described herein. The instructions 824 may reside completely or partially within the memory 804 and/or within the processor 802 during execution by the computer system 800. The memory 804 and the processor 802 also may include computer-readable media as discussed above.

In some systems, a computer-readable medium 822 includes instructions 824 or receives and executes instructions 824 responsive to a propagated signal so that a device connected to a network 110 can communicate voice, video, audio, images, or any other data over the network 110. Further, the instructions 824 may be transmitted or received over the network 110 via a communication port or interface 820, and/or using a bus 808. The communication port or interface 820 may be a part of the processor 802 or may be a separate component. The communication port 820 may be created in software or may be a physical connection in hardware. The communication port 820 may be configured to connect with a network 110, external media, the display 810, or any other components in computer system 800, or combinations thereof. The connection with the network 110 may be a physical connection, such as a wired Ethernet connection or may be established wirelessly as discussed below. Likewise, the additional connections with other components of the computer system 800 may be physical connections or may be established wirelessly. The network 110 may alternatively be directly connected to the bus 808.

While the computer-readable medium 822 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 822 is non-transitory, and may be tangible.

The computer-readable medium 822 can include a solid-state memory such as a memory card or other package that houses one or more non-volatile read-only memories. The computer-readable medium 822 can be a random-access memory or other volatile re-writable memory. Additionally or alternatively, the computer-readable medium 822 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 800 may be connected to one or more networks 110. The network 110 may define one or more networks including wired or wireless networks. The wireless network may be a cellular telephone network, an 802.11, 802.16, 802.20, or WiMax network. Further, such networks may include a public network, such as the Internet, a private network, such as an intranet, or combinations thereof, and may utilize a variety of networking protocols now available or later developed including, but not limited to TCP/IP based networking protocols. The network 110 may include wide area networks (WAN), such as the Internet, local area networks (LAN), campus area networks, metropolitan area networks, a direct connection such as through a Universal Serial Bus (USB) port, or any other networks that may allow for data communication. The network 110 may be configured to couple one computing device to another computing device to enable communication of data between the devices. The network 110 may generally be enabled to employ any form of machine-readable media for communicating information from one device to another. The network 110 may include communication methods by which information may travel between computing devices. The network 110 may be divided into sub-networks. The sub-networks may allow access to all of the other components connected thereto or the sub-networks may restrict access between the components. The network 110 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a programmed controller or computer. Those skilled in the relevant art will appreciate that aspects of the present disclosure can be practiced with other communications, data processing, or computer system configurations, including: Internet appliances, hand-held devices, etc.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium.

### INDUSTRIAL APPLICABILITY

The present disclosure may find application in autonomous machines operating over an area, such as at a construction site. For example, these machines may operate in fully autonomous, semi-autonomous, or manual operation that is coordinated by one or more supervisory systems, such as the server 120. Graphical environments may assist an operator, such as a supervisor, to review progress of one or more missions, and performance of individual machines or segments. In some aspects, an entire work area may be worked (e.g., graded and compacted) based on a single mission or group of tasks input by a supervisor, by controlling a plurality of autonomous machines, significantly reducing the amount of manual intervention required. The present disclosure may help enable multiple autonomous machines to operate over a work site efficiently, while still ensuring safety. Another aspect of the above disclosure is deployment times of machines may be calculated such that they may be operated continuously without stoppage.

It will be apparent to those skilled in the art that various modifications and variations can be made to the disclosed system without departing from the scope of the disclosure. Other embodiments of the system will be apparent to those skilled in the art from consideration of the specification and practice of the method disclosed herein. It is intended that the specification and examples be considered as exemplary only, with a true scope of the disclosure being indicated by the following claims and their equivalents.

What is claimed is:

1. A method of optimal utilization of machines for performing tasks across a predetermined area, the method comprising:
receiving a request initiated by interacting with an element of a graphical environment to perform a job on a predetermined area, the job comprising a plurality of tasks associated with a plurality of machines;
deploying, in response to the request, a first machine of the plurality of machines to the predetermined area to execute a first task of the plurality of tasks;
determining a deployment event; and
upon detection of the deployment event, deploying a second machine to the predetermined area to execute a second task of the plurality of tasks autonomously, wherein the first task and the second task are indicated as elements of the graphical environment.

2. The method of claim 1, further comprising:
presenting a plurality of segments as elements of the graphical environment, each segment being indicative of a portion of the predetermined area, wherein each of the plurality of segments is presented as a respective element of the graphical environment.

3. The method of claim 2, wherein a size of the plurality of segments is modified by interacting with the graphical environment.

4. The method of claim 2, further comprising:
presenting a notification indicating that a first segment of the plurality of segments is ready to be worked on according to the second task.

5. The method of claim 2, further comprising:
presenting an element indicative of an identity of the first machine and a location of a first segment of the plurality of segments in a same graphical environment.

6. The method of claim 1, further comprising:
generating a notification indicative of a deployment of the first machine or the second machine.

7. The method of claim 1, further comprising:
presenting an element of the graphical environment that indicates a status of the job, the status of the job being based on a status of the first task and a status of the second task.

8. The method of claim 1, further comprising:
presenting an element of the graphical environment that indicates an ability to manually operate the first machine, the second machine, or both, from a remote operation system.

9. The method of claim 1, wherein the deployment event is further determined based on an interaction with one or more of the elements of the graphical environment requesting deployment.

10. The method of claim 1, wherein the first task or the second task includes grading, filling, or compacting.

11. A system for optimal utilization of machines for performing tasks across a predetermined area, comprising:
at least one processor; and
at least one non-transitory computer readable medium storing instructions which, when executed by the at least one processor, cause the at least one processor to perform operations comprising:
receiving a request initiated by interacting with an element of a graphical environment to perform a job on a predetermined area, the job comprising a plurality of tasks associated with a plurality of machines;
deploying, in response to the request, a first machine of the plurality of machines to the predetermined area to execute a first task of the plurality of tasks;
determining a deployment event; and
upon detection of the deployment event, deploying a second machine to the predetermined area to execute a second task of the plurality of tasks autonomously, wherein the first task and the second task are displayed as elements of the graphical environment.

12. The system of claim 11, wherein the operations further comprise:
presenting a plurality of segments as elements of the graphical environment, each segment being indicative of a portion of the predetermined area, wherein each of the plurality of segments is represented as a respective element of the graphical environment.

13. The system of claim 12, wherein a size of the plurality of segments is modified by interacting with the graphical environment.

14. The system of claim 12, wherein the operations further comprise:
presenting a notification indicating that a first segment of the plurality of segments is ready to be worked on according to the second task.

15. The system of claim 12, wherein the operations further comprise:
presenting an element indicative of an identity of the first machine and an identity of a first segment of the plurality of segments in a same graphical environment.

16. The system of claim 11, wherein determining the deployment event further comprises:
generating a notification indicative of a deployment of the first machine or the second machine.

17. The system of claim 11, wherein the operations further comprise:
presenting an element of the graphical environment that indicates a status of the job, the status of the job being based on a status of the first task and a status of the second task.

18. The system of claim 11, wherein the operations further comprise:
presenting an element of the graphical environment that indicates an ability to manually operate the first machine, the second machine, or both, from a remote operation system.

19. The system of claim 11, wherein the deployment event is further determined based on an interaction with one or more of the elements of the graphical environment requesting deployment.

20. A method of optimal utilization of machines for performing tasks across a predetermined area on a construction site, the method comprising:
receiving a request to initiate a job on a predetermined area, the job comprising a plurality of tasks associated with a plurality of machines;
autonomously deploying, in response to the request, a first machine of the plurality of machines to the predetermined area to execute a first task of the plurality of tasks;
autonomously deploying a second machine to the predetermined area to execute a second task of the plurality of tasks autonomously; and
updating an element of a graphical environment based on a status of the first task and a status of the second task, the graphical environment including a plurality of segments that include a portion of the predetermined area, the first task and the second task being performed in respective segments of the plurality of segments.
